(19) United States
(12) Patent Application Publication
(10) Pub. No.: US 2026/0329812 A1
(43) Pub. Date: Oct. 22, 2026

(54) Cloud-native global file system with graph database-supported snapshot retention

(71) Applicant: Nasuni Corporation, Boston, MA (US)

(72) Inventors: Pavel Potapov, Boston, MA (US); Russell Andrew Neufeld, Newton Highlands, MA (US)

(21) Appl. No.: 19/184,009

(22) Filed: Apr. 21, 2025

(51) Int. Cl. G06F 16/16; G06F 16/14; G06F 16/18

(52) U.S. Cl. CPC G06F 16/162; G06F 16/148; G06F 16/1873

(57) ABSTRACT

A cloud-native global file system that provides snapshot retention is configured to use a graph database to maintain the state of the system. In particular, the graph database is used to represent the state of all primary file data (a tree of objects) that are stored in the cloud, and snapshot retention is performed by graph traversal operations that are much more resource efficient and simple to configure and use as compared to known approaches.

### BACKGROUND OF THE INVENTION

A graph database is a database that uses graph structures for semantic queries with nodes, edges, and properties to represent and store data. The main concept of the system is the graph (or edge or relationship). The graph relates the data items in the store to a collection of nodes and edges, the edges representing the relationships between the nodes. The relationships allow data in the store to be linked together directly and, in many cases, retrieved with one operation. A typical graph database stores both in-memory and on-disk pattern graph portions, and it provides graph query APIs. The main functions of the graph database are to bridge the semantics of a graph and low-level data storage, and to optimize graph retrieval throughput.

It is known to provide a cloud-native global file system that is used to provide primary file storage for enterprise data. In this approach, edge appliances (or “filers”) typically located on-premises securely transmit all files, file versions and metadata to a preferred private or public cloud object store, while locally caching only active files. The appliances are stateless, and multiple appliances can mount the same volume in the cloud. As files are written locally, an authoritative copy of every file and metadata (inodes) are stored in the cloud. The system provides a single, unified namespace for all primary file data that is not bound by local hardware or network performance constraints. The above-described approach to enterprise file services also has been extended to provide multiple-site/multiple-filer access to the same namespace, thereby enabling participating users with the ability to collaborate on documents across multiple filers/sites. Major cloud platforms, e.g., Amazon® AWS, Microsoft® Azure, Google® Cloud and others, are then utilized as a write-once, read many object store for the enterprise primary file data, which is typically stored in volumes. A solution of this type is available commercially as UniFS® from Nasuni® Corporation of Boston, Massachusetts.

The above-described solution is implemented as a platform designed to facilitate unlimited versioning and storage in the cloud. When a snapshot of a volume occurs, it is pushed to the cloud and expected to be available, perhaps in perpetuity (unless a policy dictates otherwise). Because the system is set up for unlimited versioning and storage in the cloud, customers may end up with a very large number of snapshots over time. To address this, the platform includes a snapshot retention feature that enables users to remove snapshots in the cloud that are not needed anymore. This in turn results in a reduced footprint in the overall capacity of storage in the cloud. Snapshot retention (also known as “pruning”) permanently removes data and snapshots from the cloud, and it is configured via a policy at a per-volume granularity. In one approach, customers can set a snapshot retention (prune) policy to keep only a set number of versions or versions of a certain age.

While pruning provides significant advantages, it is a resource intensive and lengthy process.

### SUMMARY OF THE INVENTION

A cloud-native global file system that provides snapshot retention is configured to use a graph database to maintain the state of the system. In particular, the graph database is used to represent the state of all primary file data (a tree of objects) that are stored in the cloud, and snapshot retention is performed by graph traversal operations that are much more resource efficient and simple to configure and use as compared to known approaches.

### BRIEF DESCRIPTION OF DRAWINGS

For a more complete understanding of the present invention and the advantages thereof, reference is now made to the following descriptions taken in conjunction with the accompanying drawings, in which:

FIG. 1 is a block diagram illustrating how a known versioned file system interfaces a local file system to an object-based data store;

FIG. 2 is a block diagram of a representative implementation of a portion of the interface shown in FIG. 1;

FIG. 3 is a more detailed implementation of the interface where there are a number of local file systems of different types;

FIG. 4 illustrates the interface implemented as an appliance within a local processing environment;

FIG. 5 depicts a cloud-native global file system that provides pruning natively or via Snapshot Retention-as-a-service;

FIGS. 6-9 depict several versions of a filesystem to explain how a “tree” of cloud objects is built by the cloud native global file system;

FIGS. 10-16 depict how the graph database algorithm of this disclosure marks (inventories) nodes in the tree for prune operations;

FIGS. 17-18 depicts a snapshot thinning operation that may be implemented to prune any arbitrary snapshot within a version stream according to this disclosure; and

FIG. 19 is a block diagram of a prune mechanism according to this disclosure.

### DETAILED DESCRIPTION OF THE INVENTION

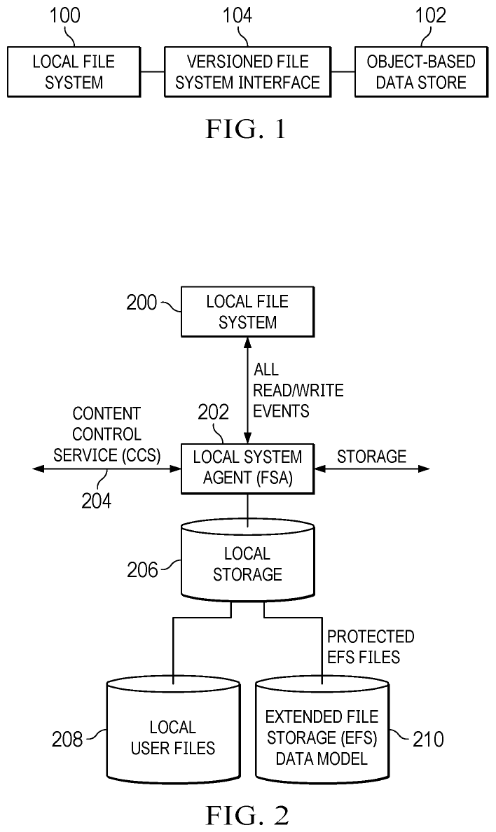

By way of background, FIG. 1 illustrates a local file system 100 and an object-based data store 102. Although not meant to be limiting, preferably the object-based data store 102 is a “write-once” store and may comprise a “cloud” of one or more storage service providers. An interface 104 (or “filer”) provides for a “versioned file system” that only requires write-once behavior from the object-based data store 102 to preserve substantially its “complete” state at any point-in-time. As used herein, the phrase “point-in-time” should be broadly construed, and it typically refers to periodic “snapshots” of the local file system (e.g., once every “n” minutes). The value of “n” and the time unit may be varied as desired. The interface 104 provides for a file system that has complete data integrity to the cloud without requiring global locks. In particular, this solution circumvents the problem of a lack of reliable atomic object replacement in cloud-based object repositories. The interface 104 is not limited for use with a particular type of back-end data store. When the interface is positioned in “front” of a data store, the interface has the effect of turning whatever is behind it into a “versioned file system” (“VFS”). The VFS is a construct that is distinct from the interface itself, and the VFS continues to exist irrespective of the state or status of the interface (from which it may have been generated). Moreover, the VFS is self-describing, and it can be accessed and managed separately from the back-end data store, or as a component of that data store. Thus, the VFS (comprising a set of structured data representations) is location-independent. In one embodiment, the VFS resides within a single storage service provider (SSP) although, as noted above, this is not a limitation. In another embodiment, a first portion of the VFS resides in a first SSP, while a second portion resides in a second SSP. Generalizing, any given VFS portion may reside in any given data store (regardless of type), and multiple VFS portions may reside across multiple data store(s). The VFS may reside in an “internal” storage cloud (i.e., a storage system internal to an enterprise), an external storage cloud, or some combination thereof.

The interface 104 may be implemented as a machine. A representative implementation is the Nasuni® Filer, available from Nasuni® Corporation of Boston, Massachusetts. Thus, for example, typically the interface 104 is a rack-mounted server appliance comprising hardware and software. The hardware typically includes one or more processors that execute software in the form of program instructions that are otherwise stored in computer memory to comprise a “special purpose” machine for carrying out the functionality described herein. Alternatively, the interface is implemented as a virtual machine or appliance (e.g., via VMware®, or the like), as software executing in a server, or as software executing on the native hardware resources of the local file system. The interface 104 serves to transform the data representing the local file system (a physical construct) into another form, namely, a versioned file system comprising a series of structured data representations that are useful to reconstruct the local file system to any point-in-time. A representative VFS is the Nasuni Unity File System (UniFS™). Although not meant to be limiting, preferably each structured data representation is an XML document (or document fragment). As is well-known, extensible markup language (XML) facilitates the exchange of information in a tree structure. An XML document typically contains a single root element (or a root element that points to one or more other root elements). Each element has a name, a set of attributes, and a value consisting of character data, and a set of child elements. The interpretation of the information conveyed in an element is derived by evaluating its name, attributes, value and position in the document.

The interface 104 generates and exports to the write-once data store a series of structured data representations (e.g., XML documents) that together comprise the versioned file system. The data representations are stored in the data store. Preferably, the XML representations are encrypted before export to the data store. The transport may be performed using known techniques. In particular, REST (Representational State Transfer) is a lightweight XML-based protocol commonly used for exchanging structured data and type information on the Web. Another such protocol is Simple Object Access Protocol (SOAP). Using REST, SOAP, or some combination thereof, XML-based messages are exchanged over a computer network, normally using HTTP (Hypertext Transfer Protocol) or the like. Transport layer security mechanisms, such as HTTP over TLS (Transport Layer Security), may be used to secure messages between two adjacent nodes. An XML document and/or a given element or object therein is addressable via a Uniform Resource Identifier (URI). Familiarity with these technologies and standards is presumed.

FIG. 2 is a block diagram of a representative implementation of how the interface captures all (or given) read/write events from a local file system 200. In this example implementation, the interface comprises a file system agent 202 that is positioned within a data path between a local file system 200 and its local storage 206. The file system agent 202 has the capability of “seeing” all (or some configurable set of) read/write events output from the local file system. The interface also comprises a content control service (CCS) 204 as will be described in more detail below. The content control service is used to control the behavior of the file system agent. The object-based data store is represented by the arrows directed to “storage” which, as noted above, typically comprises any back-end data store including, without limitation, one or more storage service providers. The local file system stores local user files (the data) in their native form in cache 208. Reference 210 represents that portion of the cache that stores pieces of metadata (the structured data representations, as will be described) that are exported to the back-end data store (e.g., the cloud).

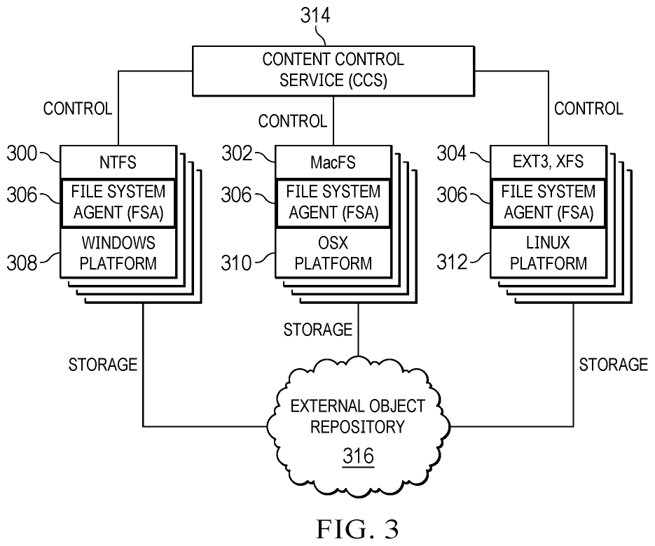

FIG. 3 is a block diagram illustrating how the interface may be used with different types of local file system architectures. In particular, FIG. 3 shows the CCS (in this drawing a Web-based portal) controlling three (3) FSA instances. Once again, these examples are representative, and they should not be taken to limit the invention. In this example, the file system agent 306 is used with three (3) different local file systems: NTFS 300 executing on a Windows operating system platform 308, MacFS (also referred to as “HFS+” (HFSPlus)) 302 executing on an OS X operating system platform 310, and EXT3 or XFS 304 executing on a Linux operating system platform 312. These local file systems may be exported (e.g., via CIFS, AFP, NFS or the like) to create a NAS system based on VFS. Conventional hardware, or a virtual machine approach, may be used in these implementations, although this is not a limitation. As indicated in FIG. 3, each platform may be controlled from a single CCS instance 314, and one or more external storage service providers may be used as an external object repository 316. As noted above, there is no requirement that multiple SSPs be used, or that the data store be provided using an SSP.

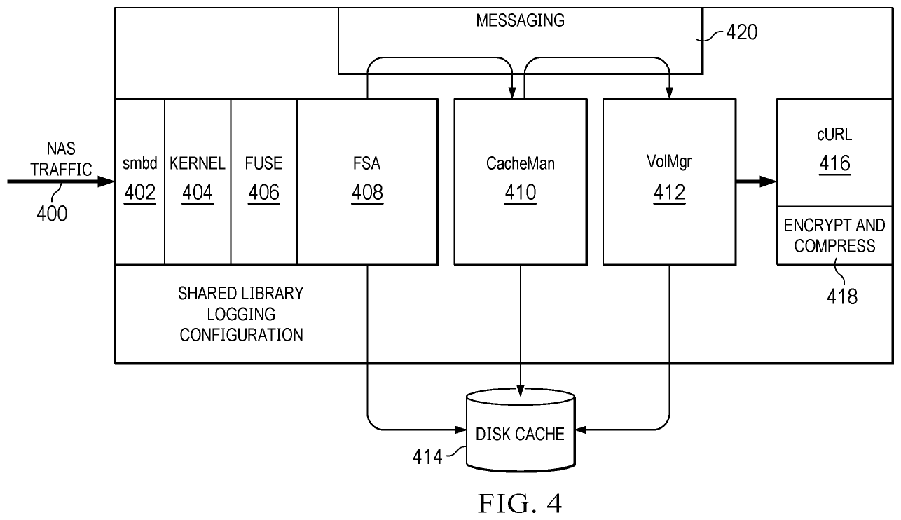

FIG. 4 illustrates the interface implemented as an appliance within a local processing environment. In this embodiment, the local file system traffic 400 is received over Ethernet and represented by the arrow identified as “NAS traffic.” That traffic is provided to smbd layer 402, which is a SAMBA file server daemon that provides CIFS (Windows-based) file sharing services to clients. The layer 402 is managed by the operating system kernel 404 is the usual manner. In this embodiment, the local file system is represented (in this example) by the FUSE kernel module 406 (which is part of the Linux kernel distribution). Components 400, 402 and 404 are not required to be part of the appliance. The file transfer agent 408 of the interface is associated with the FUSE module 406 as shown to intercept the read/write events as described above. The CCS (as described above) is implemented by a pair of modules (which may be a single module), namely, a cache manager 410, and a volume manager 412. Although not shown in detail, preferably there is one file transfer agent instance 408 for each volume of the local file system. The cache manager 410 is responsible for management of “chunks” with respect to a local disk cache 414. This enables the interface described herein to maintain a local cache of the data structures (the structured data representations) that comprise the versioned file system. The volume manager 412 maps the root of the FSA data to the cloud (as will be described below), and it further understands the one or more policies of the cloud storage service providers. The volume manager also provides the application programming interface (API) to these one or more providers and communicates the structured data representations (that comprise the versioned file system) through a transport mechanism 416 such as cURL. cURL is a library and command line tool for transferring files with URL syntax that supports various protocols such as FTP, FTPS, HTTP, HTTPS, SCP, SFTP, TFTP, TELNET, DICT, LDAP, LDAPS and FILE. cURL also supports SSL certificates, HTTP POST, HTTP PUT, FTP uploading, HTTP form based upload, proxies, cookies, user+password authentication, file transfer resume, proxy tunneling, and the like. The structured data representations preferably are encrypted and compressed prior to transport by the transformation module 418. The module 418 may provide one or more other data transformation services, such as duplicate elimination. The encryption, compression, duplicate elimination and the like, or any one of such functions, are optional. A messaging layer 420 (e.g., local socket-based IPC) may be used to pass messages between the file system agent instances, the cache manager and the volume manager. Any other type of message transport may be used as well.

The interface shown in FIG. 4 may be implemented as a standalone system, or as a managed service. In the latter case, the system executes in an end user (local file system) environment. A managed service provider provides the system (and the versioned file system service), preferably on a fee or subscription basis, and the data store (the cloud) typically is provided by one or more third party service providers. The versioned file system may have its own associated object-based data store, but this is not a requirement, as its main operation is to generate and manage the structured data representations that comprise the versioned file system. The cloud preferably is used just to store the structured data representations, preferably in a write-once manner, although the “versioned file system” as described herein may be used with any back-end data store.

As described above, the file system agent 408 is capable of completely recovering from the cloud (or other store) the state of the native file system and providing immediate file system access (once FSA metadata is recovered). The FSA can also recover to any point-in-time for the whole file system, a directory and all its contents, a single file, or a piece of a file. These and other advantages are provided by the “versioned file system” of this disclosure, as it now described in more detail below.

For more details concerning the filer as described above, the disclosure of U.S. Pat. No. 9,575,841 is hereby incorporated by reference. For additional details and examples of a cloud object store-based versioned filesystem representation, see U.S. U.S. Pat. No. 9,702,777, the disclosure of which is hereby also incorporated by reference.

The above-described services platform consolidates an enterprise's Network Attached Storage (NAS) and file server silos in cloud storage, delivering infinite scale, built-in backup, global file sharing, and local file server performance. A commercial implementation of these technologies is a software-as-a-service (Saas) platform is available from Nasuni Corporation. Enterprise customer data is stored on one or more third party clouds in a write-once, read-many (WORM) manner in a platform-specific format, namely, UniFS®-formatted volumes. This solution provides NAS consolidation, backup and recovery modernization, multi-site file sharing, and rapid, infrastructure-free disaster recovery, while also serving as a foundation for data analytics and multi-cloud IT initiatives in a manner that is now described.

The above-described platform is designed to facilitate unlimited versioning and storage in the cloud. When a snapshot of a volume occurs, it is pushed to the cloud and expected (unless a policy dictates otherwise) to be available in perpetuity. Because the system is set up for unlimited versioning and storage in the cloud, customers may end up with a very large number of snapshots over time on the platform, which is undesirable. To address this, the platform may include a snapshot retention feature that enables customers to remove snapshots in the cloud that are not needed anymore. This in turn results in a reduced footprint in the overall capacity of storage in the cloud. Snapshot retention (also known as “pruning”) permanently removes data and snapshots from the cloud, and preferably retention is configured via a policy at a per-volume granularity. In one approach, customers can set a snapshot retention (aka prune) policy to keep only a set number of versions or versions of a certain age. Snapshot retention may be supported in the system as a service.

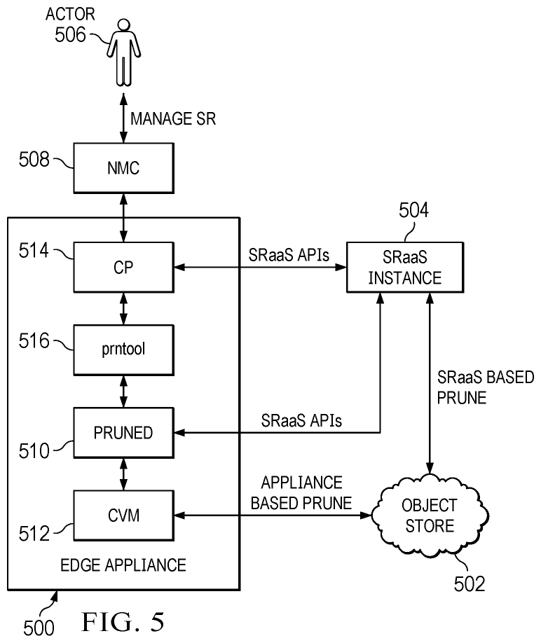

For example, FIG. 5 depicts a Snapshot Retention as a Service (SRaaS) architecture that may be implemented in the global file system described above. In the system depicted in FIG. 5, an enterprise that utilizes the solution has an edge appliance (EA) 500 that generates the tree of immutable objects stored in the cloud object store 502. In this embodiment, the service provider provides Snapshot Retention-as-a-Service (SRaaS), e.g., via the SRaaS instance 504, which is a serverless instance deployed in a cloud service (e.g., AWS, Azure Cloud Platform, etc.). The SRaaS instance 504 is accessible via SRaaS Application Programming Interfaces (APIs). An operator 506 (e.g., an enterprise customer administrator or “admin”) accesses the service through a network management console (NMC) 508 to configure or manage a snapshot retention policy for a volume on the object store 502. The edge appliance 500 supports a set of processes that facilitate pruning. In this embodiment, and as depicted, pruning can be controlled by the appliance directly (an appliance-based prune), or the appliance can interact with the SRaaS instance, which then carries out the prune operation (the SRaaS-based prune). In this example, the edge appliance is responsible for the volume (sometimes referred to as a “master” edge appliance, and the prune for the volume is run on this filer. To that end, the appliance includes a prune daemon 510 (Pruned) that initiates prune on the volume according to a policy configured at the NMC. The appliance-based prune (sometimes referred to as a local prune) means that prune for the volume runs on the appliance (and thus typically only uses resources of the appliance). The SRaaS-based prune (sometimes referred to as a cloud prune) means that prune for volume is orchestrated by the appliance, but where resource-intensive portions of the prune operation are run on the SRaaS instance 504. Regardless of where the prune is managed, it typically involves two (2) phases: keeplist generation—a phase of the prune process that generates a list of all the cloud object that should not be pruned, and delete handle—a phase of the prune process that deletes cloud object handles that are not on the keeplist.

The SRaaS architecture provides some advantages over appliance-based prune. In particular, it leverages the scalability of cloud-based resources to enable faster prunes, reduces the EA burden by off-loading compute/network intensive parts of prune to cloud services (SRaaS), gives users the ability to handle prunes entirely on their local appliance or off-loading to the cloud, and allows for appliance-backed and SRaaS-backed prunes to be run concurrently on separate volumes, with neither type blocking the other.

In a representative implementation of this service, users choose where prune is run on a per volume basis through a network-accessible user interface (UI) provided by the NMC. If a volume is configured to run prune on SRaaS, the resource intensive portions of prune are then run on an SRaaS instance. In an example embodiment, the user is provided a choice of selecting appliance-backed prune (via CVM module 512) versus SRaaS-backed prune (via CP module 514) for every volume. If the user selects SRaaS-backed prune, they are also prompted to select the SRaaS instance. The volume is registered with the SRaaS instance, and cloud credentials to access the object store are shared with SRaaS. If the user disables Snapshot Retention for a volume, a cancel will be issued for appliance-backed prune. If the volume was configured for SRaaS-backed prune, any in-progress prunes will be allowed to continue to completion. In this example embodiment, deleting a volume is a two-step process (e.g., using tool module 516): synchronous, driven by the Ul or API, an admin deletes a volume, which puts the volume in a “deleting” state; and asynchronous, driven by background tasks, during which various cleanup operations are done including the deletion of individual handles from the bucket/container and deletion of the bucket/container.

With the above as background, the techniques of this disclosure are now described. As will be seen, the techniques are an alternative to the appliance-based or SRaaS-based prune approaches. In accordance with this disclosure, the prune function instead uses a graph database (graphDB) to represent the enterprise customer data that is stored on one or more third party clouds in a write-once, read-many (WORM) manner (e.g., in a platform-specific format, such as UniFS®-formatted volumes). As noted, graph databases are specialized databases for storing nodes and relationships between those nodes. As will be seen, UniFS fits nicely into a graphDB because each handle in UniFS is treated as a node, and the linkages within the handle's XML are treated as relationships between nodes.

### Prune Using Graph Database (graphDB)

The basic operation of the prune algorithm of this disclosure is now described. The algorithm is implemented in computer software (a set of program code) executed in one or more processors (hardware, virtual machines, or combinations thereof). As will be seen, the purpose of this algorithm is to walk a tree of cloud objects (that have been stored by the cloud-native global file system) forward in time, starting with an oldest version (an oldest Table of Contents (TOC)), and building a representation of the tree in a graph database (graphDB) that is then useful for pruning operations. The TOC is a root node. Preferably, each node in the graphDB has several attributes, namely a handle (a name of the object in an object store), a version (an integer value or a special value ‘live’), and a reference count (an integer value representing how many nodes point to this node).

Each filesystem snapshot (with a root node, namely the TOC), has an increasing integer associated with it, and that integer value is the version. This version is used in the prune algorithm. In addition, a special version of this attribute, which is referred to herein as “live,” is an attribute that some nodes get instead of an integer version. In the approach, all nodes in the graphDB that end up with a version of “live” are reachable from the current TOC (the “now” snapshot) and thus are not candidates for prune. On the other hand, all nodes in the graphDB with an integer version X or lower are only reachable from TOCs with snapshot versions X or lower, and thus are candidates for prune. With this background, the following describes the operation of a marking (inventory) phase of the algorithm, which phase is used to build up the representation of a tree of objects that are stored in an object store.

At a first step, the algorithm starts with TOC version 1 (or the lowest/oldest TOC), recursively traversing all reachable handles and represents them in the graphDB as nodes with parent/child relationships, setting their version attributes “live” and their reference counts to “1.” Next, the algorithm then considers subsequent TOC pairs, with their versions being Vₙ and Vₙ₊₁. (As used here, versions Vₙ and Vₙ₊₁ refers to the versions of the filesystem stored as cloud objects in the tree, as opposed to the version attribute in a graph node). A processing loop is then initiated. In particular, and starting with TOC Vₙ₊₁ in UniFS, all reachable child handles (excluding links which point to previously TOCs) are recursively traversed. For a given handle, the following processing is carried out. In particular, if the handle does not exist in the graphDB, then a node is created in the graphDB for the handle, the node is added to a set called new, and the node's reference count is set to 1. The routine then continues recursively traversing all reachable child handles. If a node for this handle exists in the graphDB and its version attribute is “live,” then the node is added to the new set, its reference count is increment by 1, and recursing is stopped. If a node exists in the graphDB and has an integer in the version attribute, the node's reference count is incremented by 1 and the node and all reachable children are added to the new set; the reference count(s) of any of the reachable children, however, are not incremented. This completes the loop.

Thereafter, and at a second step, and starting with the node in the graph database representing TOC Vₙ, the algorithm recurses all reachable child nodes and carries out the following processing. If a node's version is “live” in the graphDB and the node is not in the new set, the node's version attribute is update in the graphDB to n, and recursing continues. If, however, a node's version attribute is “live” in the graphDB and the node is in the new set, recursing is stopped. Thereafter, the version attribute of every node in the new set is set to “live” in the graphDB and the new set is set to empty.

Then, the algorithm continues at a third step, repeating the processing in step 2 using version pairs Vₙ₊₁ and Vₙ₊₂ until processes reaches a most recent TOC. This completes the processing.

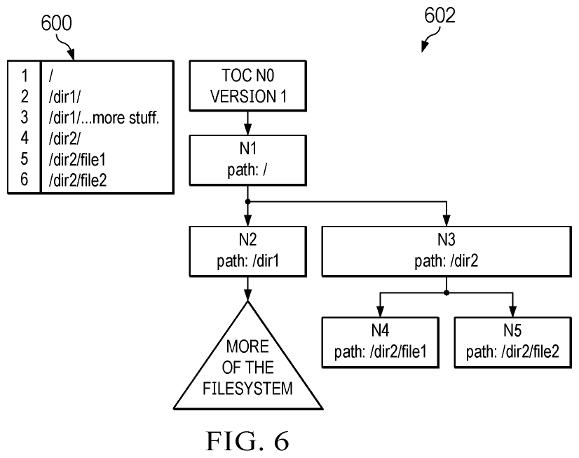

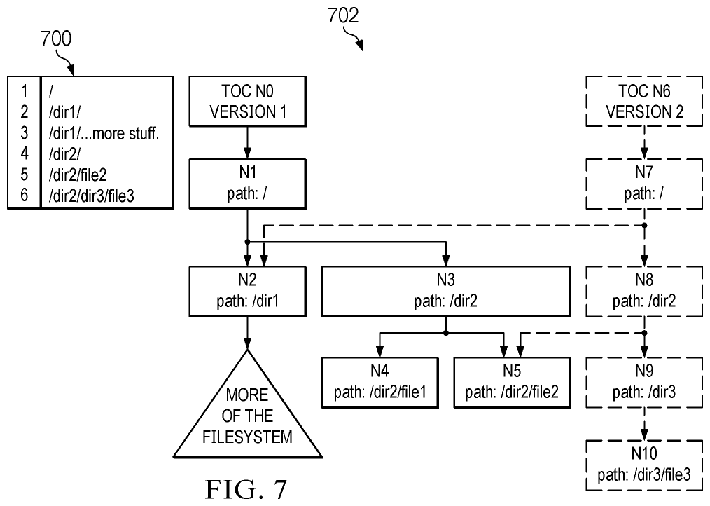

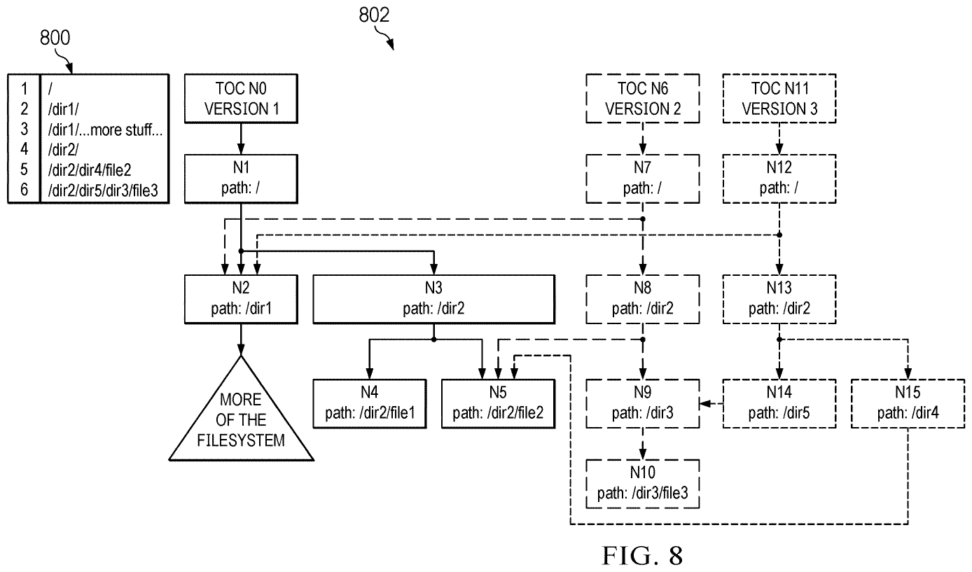

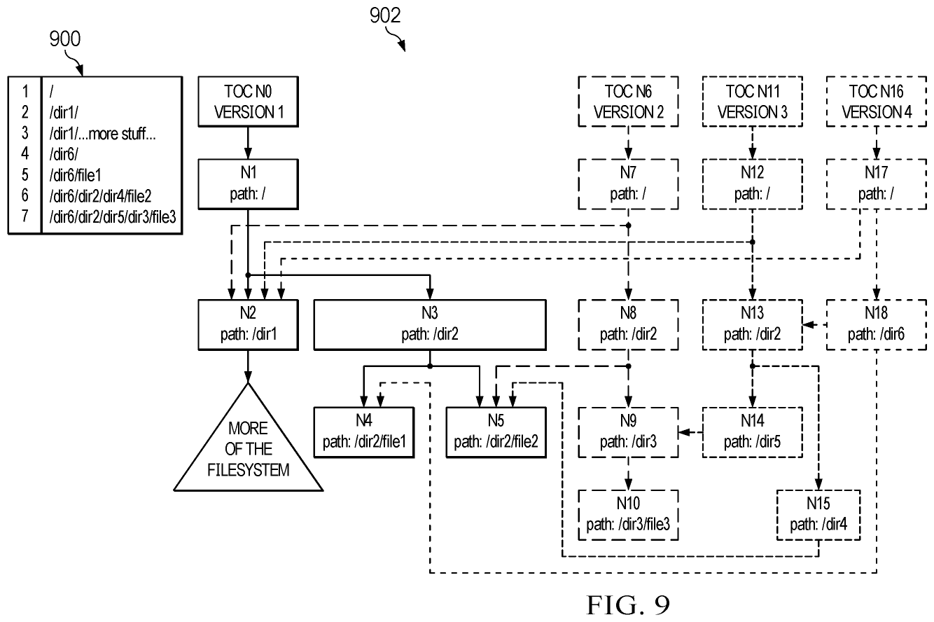

FIGS. 6-9 depict the operation of the algorithm to an example tree. To that end, these figures depict setting up several versions of the filesystem to show how the tree gets built and how the algorithm marks node in the tree for prune operations. Note that in the diagrams shown the link from TOC Vₙ₊₁ to TOC Vₙ has been omitted so as to not complicate the notion of walking all reachable nodes from a TOC but excluding the TOC-to-TOC linkages. In particular, FIG. 6 depicts a filesystem 600 with one version (Version 1), together with its corresponding tree 602 in the cloud object store. The directory manifests/directory chunks and file manifests/file chunks are also simplified for readability. Now, suppose/dir2/file1 is deleted and/dir/dir/file 3 is added to the filesystem. FIG. 7 depicts the resulting Version 2 of filesystem 700 and its corresponding tree 702. Now, suppose file2 is moved to a new directory/dir2/dir4, and that directory dir3 is moved to a new directory/dir2/dir5. FIG. 8 depicts the resulting Version 3 of the filesystem 800 and its corresponding tree 802. Finally, suppose a new directory/dir6 is created, file1 is restored to/dir6, and directory/dir2 is moved into/dir6. FIG. 9 depicts the resulting Version 4 of the filesystem 900 and its corresponding tree 902.

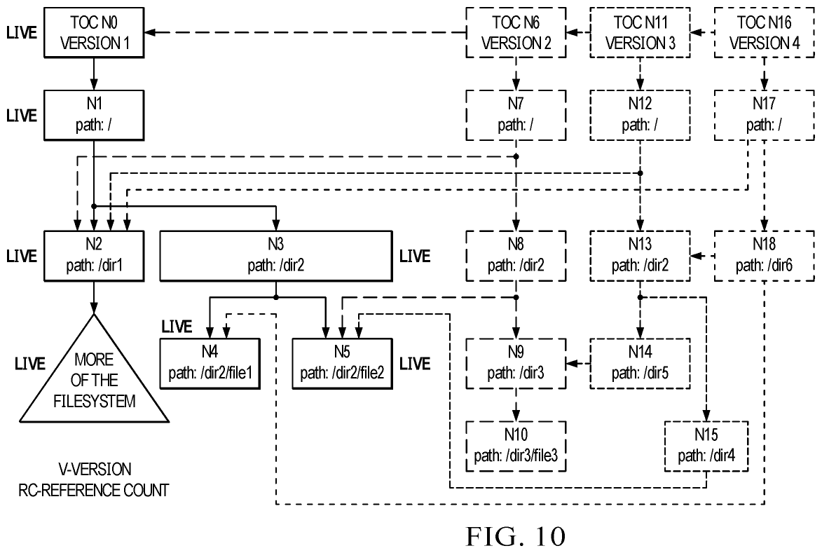

With the above-described and depicted tree, FIGS. 10-16 depict how the algorithm builds up the representation of the tree in the graph DB. (In these figures, a solid border box represents an existing node/handle, a dotted border box represents a deleted node/handle, a solid arrow represents an existing pointer, and a dotted arrow represents a new pointer added by a new version of the tree). In this operation, and as will be seen, the version attribute of each node is set to either an integer or “live,” and the reference count attribute is set to an integer value. To simplify the illustrations, FIGS. 10-12 show both the tree and the values that are stored in the graphDB (overlayed on the tree). The handle attribute is assumed in all nodes and omitted for clarity. In a first step, the oldest snapshot is marked as “live.” This first step of the marking phase traverses all reachable children from node N0 (the first TOC) and records their versions as “live” and their reference counts as 1 in the graph DB. The result of this first step is depicted in FIG. 10.

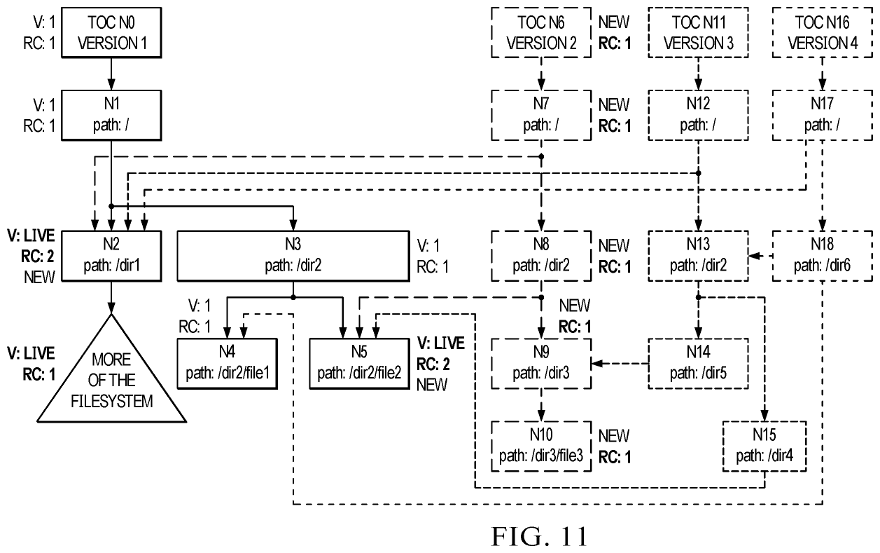

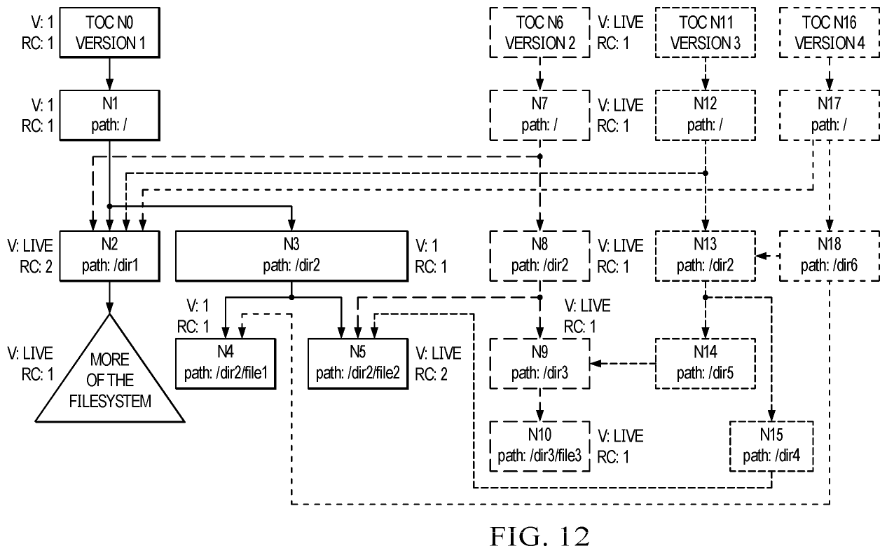

At a second step of the marking phase, a number of marking passes are implemented, which are now described and depicted. In a first pass, the algorithm (as previously described) considers subsequent pairs of TOCs (Vₙ and Vₙ₊₁). In this example this corresponds to Versions 1 and 2 (FIGS. 6 and 7 above), namely, nodes N0 and N6. So, starting at node N6 and traversing all reachable children, the above-described three (3) steps of the algorithm are carried out. In this example, the new set consists of {N6, N7, N8, N9, N10, N2, N5}. According to the algorithm, and now starting with TOC Vₙ (N0), all reachable child nodes are recursed. In this case, the algorithm ends up setting version to “1” on nodes N0, N1, N3 and N4 in the graphDB, as these nodes are reachable from N0, are marked “live,” and are not in the new set. This result is depicted in FIG. 11. Thereafter, and corresponding to the third step of the algorithm, everything in the new set is marked as “live” in the graphDB and the new set is set to empty. The result is depicted in FIG. 12. As depicted there, all nodes with version 1 are then delete-able if an operator were then to prune version 1. Everything reachable from TOC version 2 is marked as “live,” and all nodes reachable from TOC version 1 but not reachable from TOC version 2 are marked with version 1. It is then a straightforward operation on the graph database to query for all nodes with version 1 and delete them, if desired.

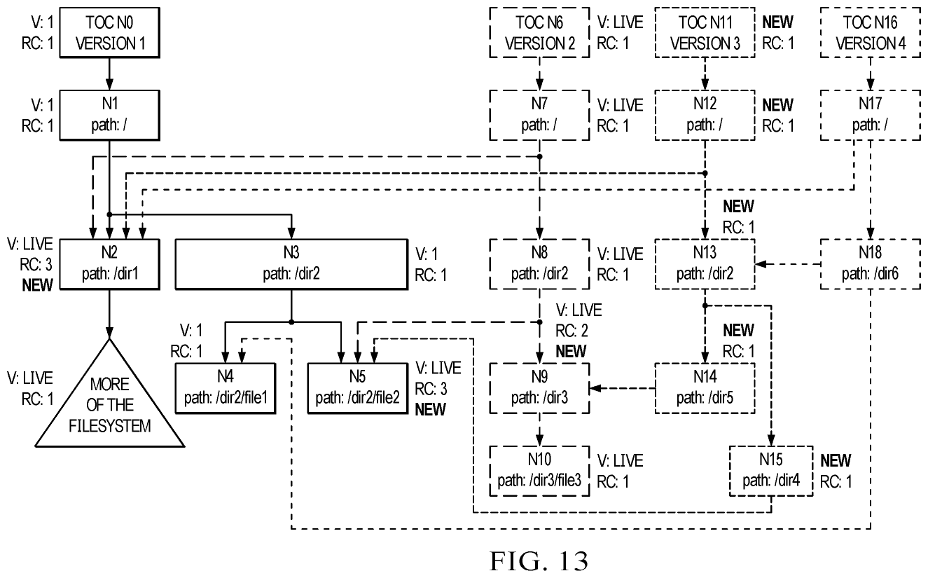

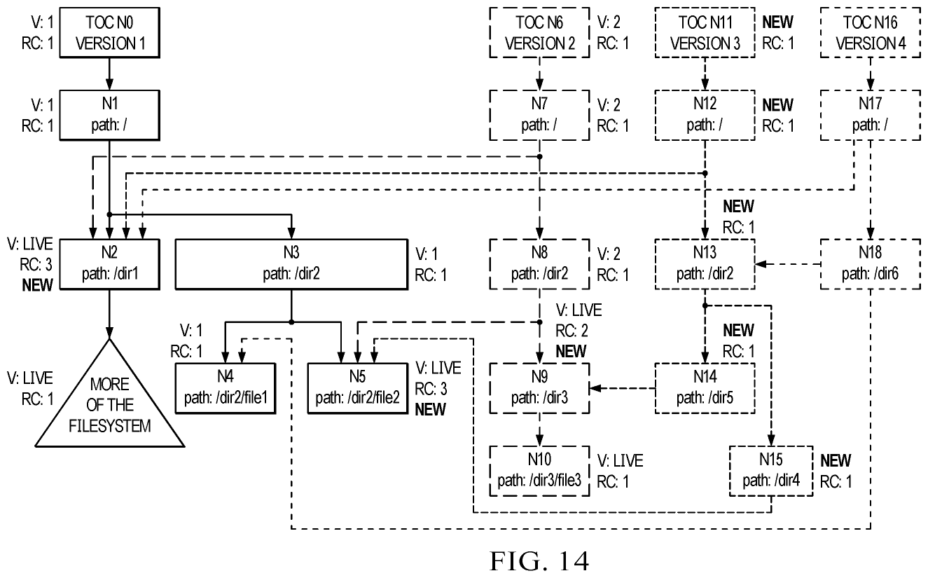

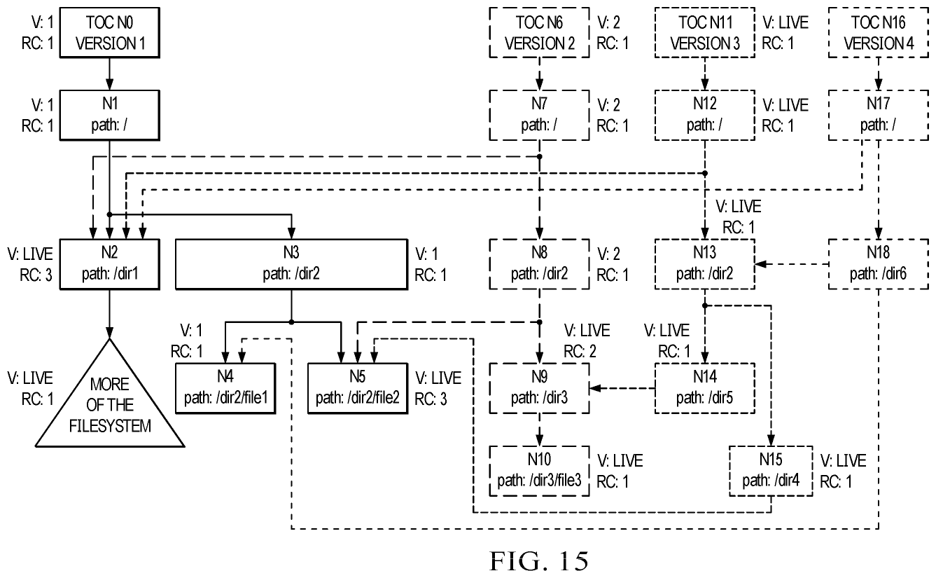

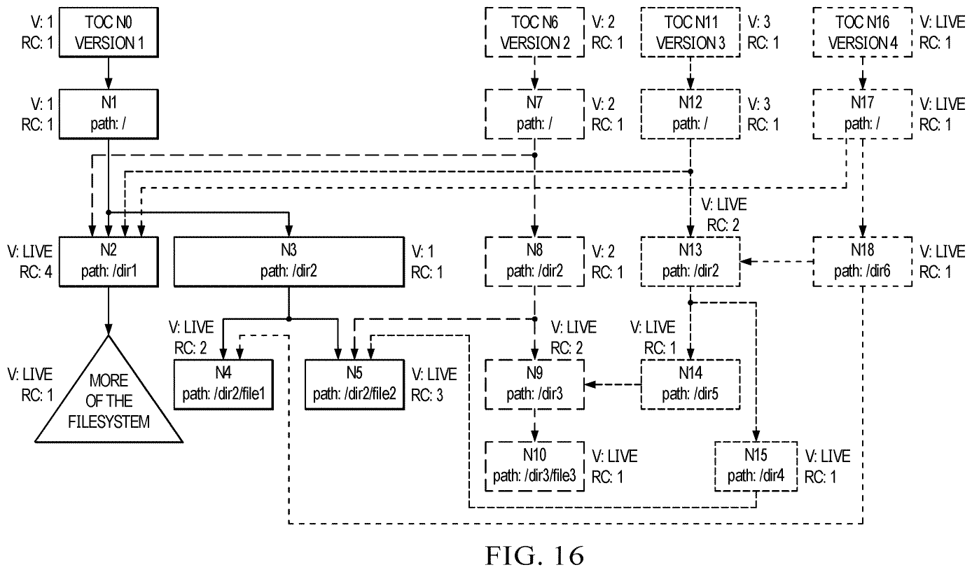

A second pass of the marking phase in then carried out, as is now described. In particular, and as previously described, the algorithm considers subsequent pairs of the TOCS, and in this case Versions 2 and 3 (FIGS. 7 and 8), or nodes N6 and N11. As before, the marking phase traverses all reachable children from node N6 (the first TOC) and records their versions as “live” and their reference counts as 1 in the graph DB. The result of this first step is depicted in FIG. 13. The resulting new set consists of nodes {N11, N12, N13, N14, N15, N2, N5, N9}. The algorithm then starts with TOC Vₙ (N6) and recurse all reachable child nodes. In this example, the algorithm ends us setting version to “2” on nodes N6, N7 and N8 in the graphDB, as these nodes are reachable from N6, are marked “live,” and are not in the new set. FIG. 14 represents this result. Finally, everything in the new set {N11, N12, N13, N14, N15, N2, N5, N9} is marked to “live.” The result is shown in FIG. 15. As can be seen, at this point all the nodes with versions 1 and 2 are delete-able if an operator were to prune version 2 and earlier. Everything reachable from TOC version 3 is marked as “live,” and all nodes reachable from TOC versions 1 and 2 but not reachable from version 3 are marked with either version 1 or 2. Once again, at this point it is a straightforward operation on the graph database to query for all nodes with version less than or equal to 2 and delete them, if desired.

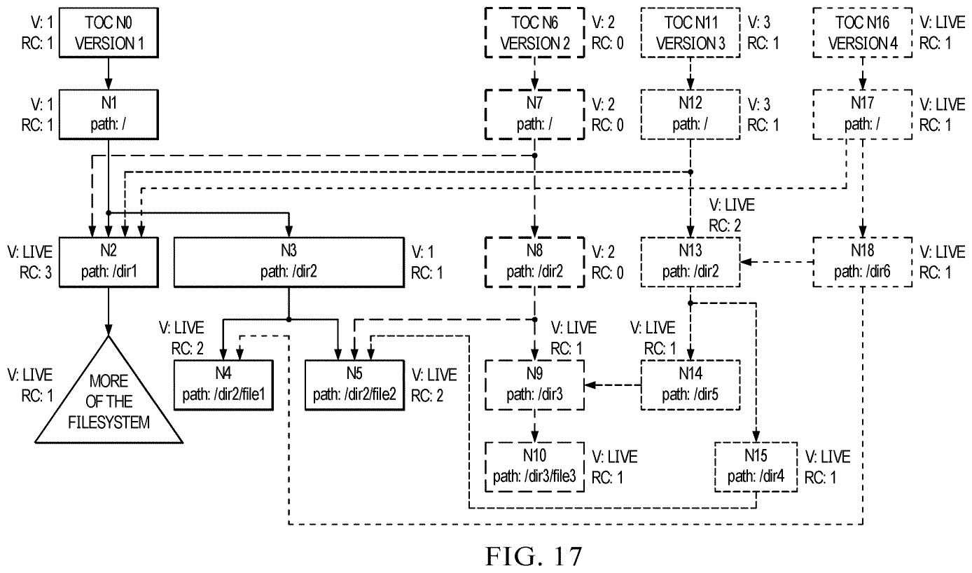

In a third pass, the algorithm considers the last subsequent pair, namely, TOC Versions 3 and 4, or nodes N11 and N16. Running through the algorithm again (skipping the interim steps for brevity), nodes N11 and N12 get marked with version 3, and node N4 (among others) is marked “live” because it was restored in this version and is now reachable from TOC version 4 (N16) via N16→N17→N18→N4. The resulting graphDB representation of the tree is depicted in FIG. 16. Once again, if it were desired to prune all versions prior to Version 4, a simple query of all nodes in the graphDB with version less than 4 would return a list nodes that are safe to delete.

An advantage of the graph database herein is that the algorithm keeps state (in the graphDB), which means that once a version is inventoried it does not need to be visited again. The state of older snapshots is built once and maintained in the graphDB. Only new snapshots need to be traversed and added to the inventory in the graphDB.

As described in the above example scenario, once the tree (e.g., UniFS) handles have been translated into nodes with versions in the graphDB, the determination of which nodes to delete given some prune criteria is straightforward. For example, assume an operator wants to delete all older versions of the tree starting with an earliest version and going up and including version N, a prune orchestrator component (e.g., the Pruned daemon described above, or an equivalent server-based functionality) queries the graphDB for all nodes with version ≤N and deletes those.

According to a further aspect, a snapshot retention mechanism/service may implement snapshot thinning. Snapshot thinning is the notion of deleting arbitrary snapshots within a version stream. For example, an operator may want a policy whereby after a given time period they only want to keep one snapshot per day, or after some longer time perhaps only one snapshot per month, and so forth. In other words, the operator wants to “thin” their version history of extraneous snapshots. This requires the ability to delete snapshots within the version stream (preserving newer and older snapshots). This operation can be accomplished as follows for deletion of a single arbitrary version. Thinning multiple snapshots is then achieved by running this algorithm repeatedly on candidate snapshots. Starting with a TOC representing the root of a snapshot to be thinned, its node in the graphDB is obtained. If the node's version attribute is “live,” the node's reference count is decremented. If the node's version attribute is an integer value, the node's reference count is decremented. If at this point the reference count is 0, the node (and its corresponding handle in the tree) are deleted. The above steps are repeated for all of the node's children, except that links from TOCs to other TOCs are not followed.

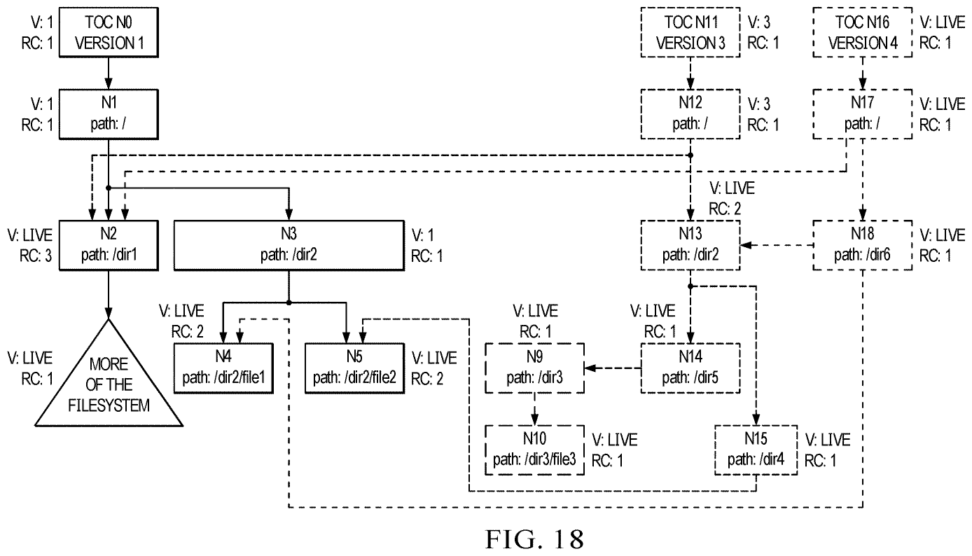

Using the above versioned filesystem example, suppose the operator wants to delete TOC version 2 from the filesystem. The thinning functionality starts in the graphDB with the node that represents the TOC for version 2 and decrements its reference count, which now becomes 0. Because the node does not have a version of “live,” it is able to be deleted. The same algorithm is then applied to all of its children. FIG. 17 depicts what the graphDB looks like prior to deleting any node with reference count equal to 0. The nodes that can be deleted are highlighted with the dashed line (in this example, nodes N6-N8). When the nodes with reference count are deleted, the corresponding handles in the tree are deleted, the resulting filesystem (and graphDB) is as depicted in FIG. 18.

The above-described example tree and its associated graphDB representation are for exemplary purposes and are not intended to be limiting.

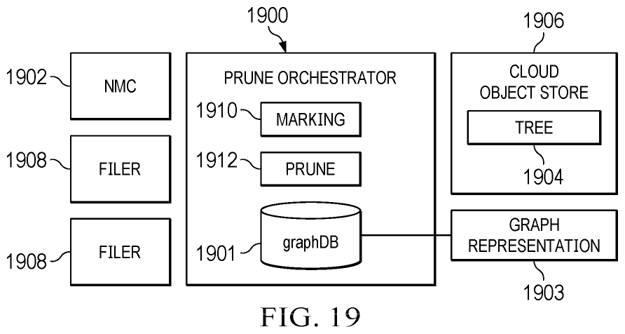

FIG. 19 is a high-level block diagram of the above-described functions. In this embodiment, a prune orchestrator 1900 (such as the Pruned daemon mentioned above) is configured in a computing system, typically as software executing on one or more hardware processors, and a graph database 1901 is associated with the prune orchestrator. The orchestrator 1900 is also associated with a network management center 1902 at which a prune policy may be configured and instantiated. A tree 1904 of versions of a filesystem is assumed to be stored persistently in a cloud object store 1906 that typically is managed by one or more cloud service providers. The objects that comprise the tree originate from one or more filers 1908, all as previously described. According to this disclosure, the prune orchestrator comprises a marking (or inventory) function 1910, and a prune function 1912, all as previously described by way of the example scenarios. The inventory function 1910 may be carried out periodically, and as new snapshots are generated. The result of the inventory is a graph database representation 1903 of the tree 1904. Via the NMC, an operator configures a prune policy, which is then applied by the prune function 1912 to implement the policy. The nature of the policy may vary, e.g., from deleting oldest versions by count or by time, or by pruning arbitrary snapshots within a version stream. A prune policy may also be pre-configured or otherwise implemented programmatically by the system.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be specially constructed for the required purposes, or it may comprise a computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A computer-readable medium having instructions stored thereon to perform the interface functions is tangible.

A given implementation of the disclosed subject matter is software written in a given programming language that runs on a server on an hardware platform running an operating system such as Linux. As noted above, the interface may be implemented as well as a virtual machine or appliance, or in any other tangible manner.

While given components of the system have been described separately, one of ordinary skill will appreciate that some of the functions may be combined or shared in given instructions, program sequences, code portions, and the like.

What is claimed follows below.

1. A computer-implemented method of managing a versioned file system stored in a private, public or hybrid cloud object store, the versioned file system stored as a tree of versions of a filesystem, a version having been created as a snapshot, comprising:
receiving given information obtained from walking the tree starting from a given version;
based on the given information, building a graph representation of the tree;
storing the graph representation in a graph database;
responsive to a query to the graph database, the query identifying one or more versions of the versioned file system for deletion, traversing the graph and returning a set of one or more nodes of the graph;
deleting from the graph the set of one or more nodes returned; and
providing signaling that controls the private, public or hybrid cloud object store to automatically prune, from the versioned file system, one or more snapshots associated with the set of one or more nodes deleted from the graph.

2. The computer-implemented method as described in claim 1, wherein, for each given node in the graph database, the given information comprises a first attribute corresponding to a name of an object in the object store, a second attribute that is an integer value or an identified state, and a third attribute that is an integer value representing a number of nodes that point to the given node.

3. The computer-implemented method as described in claim 2, wherein the first attribute is a handle in the tree.

4. The computer-implemented method as described in claim 2, wherein the nodes in the graph database that have the second attribute with the identified state represent versions of the versioned file system that are reachable from a current version snapshot and thus are not candidates for being pruned.

5. The computer-implemented method as described in claim 2, wherein the nodes in the graph database that have the second attribute that is an integer value X or lower are reachable from snapshot versions X or lower and thus are candidates for pruning.

6. The computer-implemented method as described in claim 2, wherein building the graph representation of the tree comprises recursively traveling all reachable handles in the tree starting from the given version and representing them in the graph database as one or more graph nodes with parent and child relationships, and setting the second and third attributes for each graph node.

7. The computer-implemented method as described in claim 5, further including setting the second attribute of the node to the identified state, and setting the third attribute integer value to 1.

8. The computer-implemented method as described in claim 1, wherein the given version is an oldest version of the tree of versions.

9. The method as described in claim 1, wherein the one or more versions of the versioned file system identified for deletion include the given version.

10. The computer-implemented method as described in claim 1, wherein the one or more versions of the versioned file system identified for deletion include any arbitrary version of the tree of versions.

11. The computer-implemented method as described in claim 1, further including receiving a prune policy identifying the one or more versions of the versioned filesystem identified for deletion.

12. The computer-implemented method as described in claim 1, further including updating the graph representation of the tree in association with storage of a new version in the versioned file system.

13. The computer-implemented method as described in claim 1, wherein the graph representative maintains a state of the versioned file system.

14. The computer-implemented method as described in claim 3, wherein edges associated with a node in the graph representation represents a linkage between a handle and one or more other handles in the tree.

15. The computer-implemented method as described in claim 1, wherein the tree of versions are associated with a volume.
